(19) United States
(12) Patent Application Publication
(10) Pub. No.: US 2012/0244385 A1
(43) Pub. Date: Sep. 27, 2012

(54) METAL HOUSING AND SURFACE TREATING METHOD THEREOF

(75) Inventors: MU-CHI HSU, Tu-Cheng (TW); SHAO-MING FU, Tu-Cheng (TW)

(73) Assignee: HON HAI PRECISION INDUSTRY CO., LTD., Tu-Cheng (TW)

(21) Appl. No.: 13/276,310

(22) Filed: Oct. 18, 2011

(30) Foreign Application Priority Data
Mar. 24, 2011 (TW) 100109998

(51) Int. Cl. B05D 3/10; B32B 15/01; B05D 1/12; B32B 15/04; B05D 3/02; H05H 1/24

(52) U.S. Cl. 428/656; 427/328; 427/319; 427/576; 427/180; 427/250; 427/352; 428/660

(57) ABSTRACT

A surface treating method of a metal housing includes the following steps. First, a workpiece is provided. The workpiece includes a surface formed by a metal material. Thereafter, the workpiece is pre-treated to clean the surface of the metal material. Next, a titanium diffusion treating is performed on the workpiece to form a titanium-containing diffusion layer on the surface of the metal material.

### BACKGROUND

1. Technical Field

The present disclosure relates to a housing and a surface treating method, and particularly, to a metal housing and a surface treating method of the housing.

2. Description of Related Art

The development of electronic products and portable electronic devices such as mobile phones, music players, and personal digital assistants have allowed people to express themselves through the use of technology. The appearance of these portable electronics devices can become a selling point. A metal layer is usually formed on the surface of the portable electronic device, or the portable electronic device is assembled with a metal housing, to give a metallic texture to these devices.

A coating layer is usually coated on the outer surface of the metal to protect the metal from corrosion, scratches, abrasion and oxidation. Although the outer coating layer can provide some protection for the electronic devices, the outer coating layer may corrode or peel off, leaving a mottled appearance of the electronic devices.

Accordingly, it is desirable to provide metal housing and a related surface treating method which can overcome the described limitations.

### BRIEF DESCRIPTION OF THE DRAWINGS

Many aspects of the disclosure can be better understood with reference to the drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is a flowchart of a surface treating method of a housing according to a first embodiment of the present disclosure.

FIG. 2 is a schematic view of a pre-treatment of FIG. 1.

FIG. 3 is a schematic view of a salt bath titanium diffusion treatment of FIG. 1.

FIG. 4 is a cross section view of a formed metal housing of FIG. 1.

FIG. 5 is a schematic view of a glow-discharge titanizing with an arc source according to a second embodiment of the present disclosure.

FIG. 6 is a cross section view of a formed metal housing of FIG. 5.

FIG. 7 is a schematic view of a solid titanium diffusion according to a third embodiment of the present disclosure.

FIG. 8 is a cross section view of a formed metal housing according to a fourth embodiment of the present disclosure.

FIG. 9 is a cross section view of a formed metal housing of FIG. 8.

FIG. 10 is a flowchart of a surface treating method of a housing according to a fifth embodiment of the present disclosure.

### DETAILED DESCRIPTION

Embodiments of the disclosure are now described in detail with reference to the accompanying drawings.

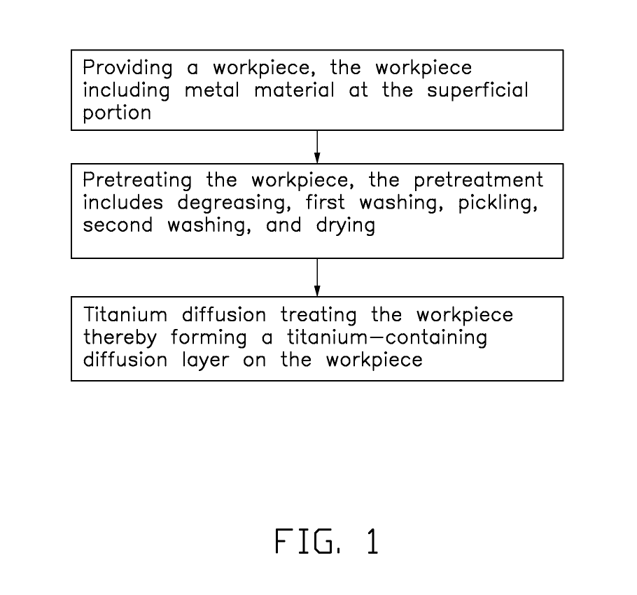

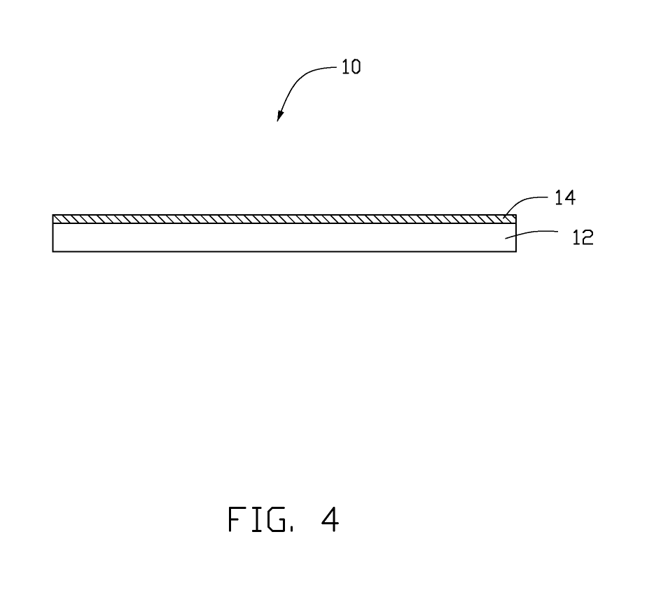

FIG. 1 through FIG. 3 illustrate a surface treating method for a metal housing, and FIG. 4 illustrates the formed metal housing. The metal housing 10 of the present disclosure can be widely used in automotive, electronics, telecommunications and other fields, especially if the product housings require metallic texture and high surface hardness, such as computer cases, cars, mobile phone housing, and so on.

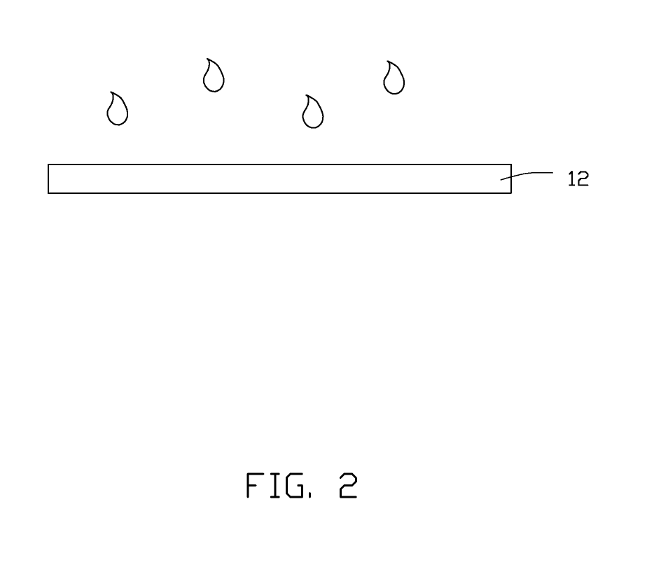

As shown in FIG. 1 and FIG. 2, a workpiece 12 is provided, and a pretreatment is performed on a surface formed by a metal material of the workpiece 12. The metal material provides the metallic texture. In this embodiment, the whole workpiece 12 is made of metal, such as stainless steel, copper, iron, titanium, aluminum, magnesium or any alloy thereof. For example, the whole workpiece 12 is made of stainless steel in this embodiment, but not limited thereto.

The purpose of the pretreatment is to clean the surface of the metal material. The pretreatment can remove grease and pollutions from surfaces of the metal material of the workpiece 12 without damaging the superficial structure of the workpiece, so that subsequent processing can be easily performed and adhesion between the workpiece 12 and the following-formed layer is promoted. The treated surface may be a partial outer surface or the entire outer surface of the workpiece 12.

The pretreatment may include steps of degreasing, washing, pickling, washing again and drying, but not limited thereto. First, the pre-degreasing step removes grease pollutions from surfaces of the workpiece 12 by using, for example, strong acid solvent to generally break the bonding between the grease and the workpiece 12. Afterward, a main-degreasing step is performed to further removes grease pollutions from the workpiece 12 by using degreasing solvent, but not to damage the surface of the workpiece 12. Next, the workpiece 12 is washed to remove the residual acid solvent and other pollutions. Furthermore, the pickling step adjusts the activation of the surface of the workpiece 12, counteracts the residual degreasing solvent, and improves the adhesion of the surface of the workpiece 12. Thereafter, the workpiece 12 is washed again to remove the residual acid, pollutants, electrolyte and dissoluble salt. Next, the workpiece 12 is dried, and a clean surface is prepared for the follow processes.

Following up, a titanium diffusion treatment is performed on the workpiece 12 to promote hardness and corrosion resistance. The titanium diffusion treatment may be powder diffusion, liquid diffusion, gas diffusion, solid diffusion, arc added glow discharge plasma titanium diffusion, double glow plasma titanium diffusion, or multi-arc plasma titanium diffusion.

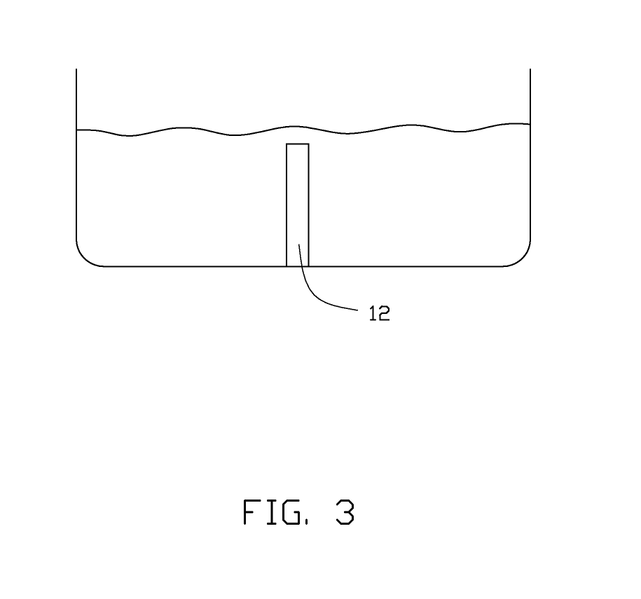

As shown in FIG. 3, the workpiece 12 is soaked in a moderately heated non-electrolyzed salt bath which contains activated-electrolyzed metallic titanium. The salt bath includes sodium dioxide and sodium cyanate, or sodium dioxide and potassium cyanate. The workpiece 12 is soaked at a temperature from about 550° C.-600° C., for a time of about 1 hour-20 hours. Ideally, the workpiece 12 is soaked for about 2 hours-10 hours. The electrolyzed titanium catalyzes the diffusion of the titanium and nitride to penetrate the workpiece 12 about 20 microns-125 microns.

As shown in FIG. 4, a titanium-containing diffusion layer 14 is formed on surface of the workpiece 12, and a metal housing 10 is manufactured. The titanium-containing diffusion layer 14 includes a stainless steel layer doped by titanium and nitride, and has a thickness between about 20 microns-125 microns. Titanium and nitride fill the voids among the grains of the metal material. Consequently, the titanium-containing diffusion layer 14 will include titanium and nitride.

In comparison with an un-doped metal housing, the titanium-containing diffusion layer 14 can effectively increase the surface hardness of the metal housing 10 up to HRC (scale hardness Rockwell C) 60, or sometimes more than HRC 70. The titanium-containing diffusion layer 14 also increase the resistance to wear, heat and corrosion of the metal housing 10, which promotes a longer life. In comparison with a traditional titanium diffusion treatment, the titanium diffusion treatment in this embodiment is operated at a lower temperature, so the treatment can avoid geometric distortions or warping of the metal housing 10. The salt bath of the titanium diffusion treatment is especially suitable for cases that require uniformed doping or a doping on a large-sized metal house 10.

Referring to the texture, the present disclosure can increase the surface hardness of the metal housing 10 without coating additional non-metallic layer. In addition, the present disclosure can maintain the size and the physical; characteristics of the original workpiece 12, such as thickness, color and texture. Thus, housings having metallic texture and high surface hardness can be used for various applications.

Taking a stainless steel workpiece as an example, a stainless steel housing can provide a mirror surface texture, while an aluminum housing can only provide a mirrored surface due to aluminum oxide. However, while a traditional stainless steel housing is scratched, a scratch produced on the stainless steel surface will not be oxidized to form a dense oxide layer protecting the defect, and the scratch is even more noticeable on the mirror surface. By comparison, the present disclosure performs the titanium diffusion treatment on the stainless steel workpiece to strengthen the surface hardness, so the present disclosure can prevent scratches, and the metallic mirror surface is effectively protected.

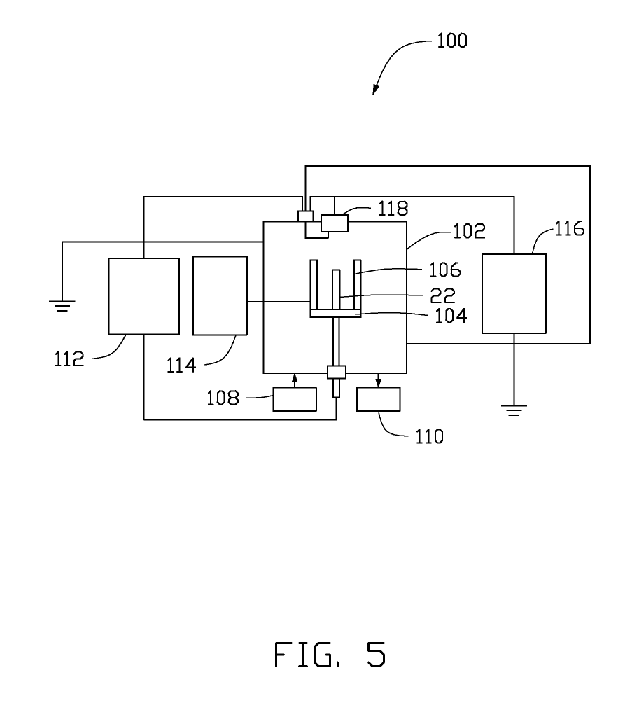

As shown in FIG. 5, the second embodiment is similar to the first embodiment, but the titanium diffusion treatment of the second embodiment is a glow-discharge tetanizing with an arc source. A glow discharge plasma arc apparatus 100 includes a treating chamber 102, a cathode electrode 104, an auxiliary electrode 106, a gas-supply system 108, a gas-exhaust system 110, a first power-supply system 112, a second power-supply system 114, a third power-supply system 116, and an anode electrode 118. The pressure in the treating chamber 102 is controlled through the gas-supply system 108 and the gas-exhaust system 110, and it is near a vacuum state in the treating chamber 102. The workpiece 22 is first positioned in the treating chamber 102 of the glow discharge plasma arc apparatus 100, among the cathode electrode 104, the auxiliary electrode 106 and the anode electrode 118. The anode electrode 118 can provide titanium. For example, there is titanium target, such as titanium metal or titanium compound, located adjacent to the anode electrode 118. The first, second and third power-supply systems 112, 114, 116 provide direct current to cause glow discharge and arc discharge. The discharge causes high power titanium ion and high power titanium atom to bombard the surface of the workpiece 22. Thus, the workpiece 22 increases in temperature, and titanium is diffused into the workpiece 22 to form a titanium-containing diffusion layer 24.

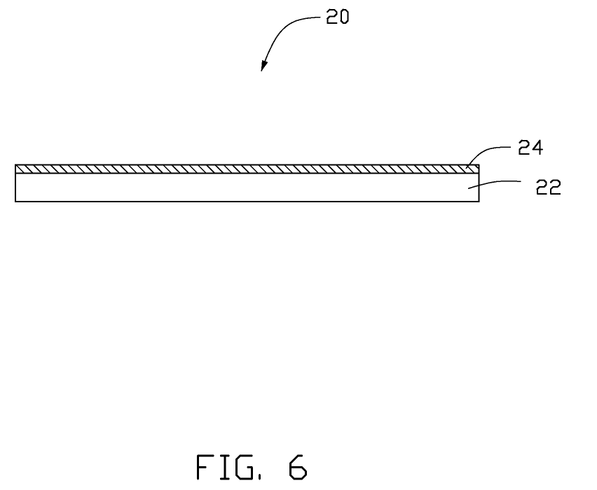

As shown in FIG. 6, the metal housing 20 includes the workpiece 22 and the titanium-containing diffusion layer 24 thereon. If the workpiece 22 is laid flat on the cathode electrode 104 in other embodiments, or if the partial surface of the workpiece 22 is covered by a mask, the titanium-containing diffusion layer 24 may only formed on partial surface of the workpiece 22, but is not limited thereto.

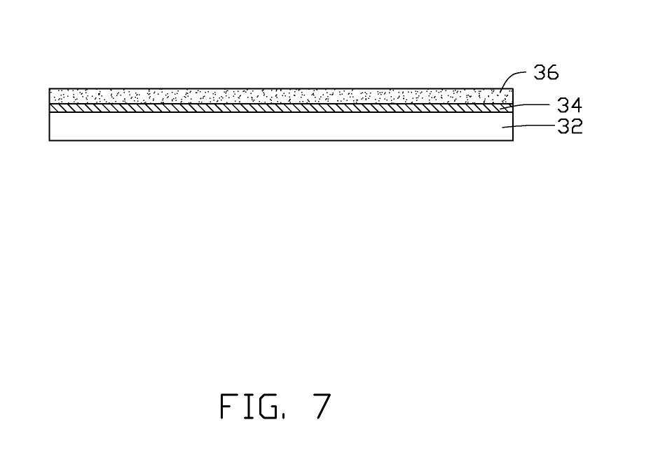

As shown in FIG. 7, the third embodiment is similar to the first and second embodiments, but the titanium diffusion treatment of the third embodiment is performed by heating. A titanium-containing layer 36 is first formed on a clean surface of the workpiece 32, and the workpiece 32 is next heated to diffuse titanium into the workpiece 32 to form a titanium-containing diffusion layer 34. Afterward, a titanium-containing layer 36 is removed to form the metal housing. This titanium diffusion treatment does not use an electrolyte salt or a titanium target, so this titanium diffusion treatment is not limited by the electrolyte salt or titanium target. Various kinds of titanium-containing layer 36 can be adopted.

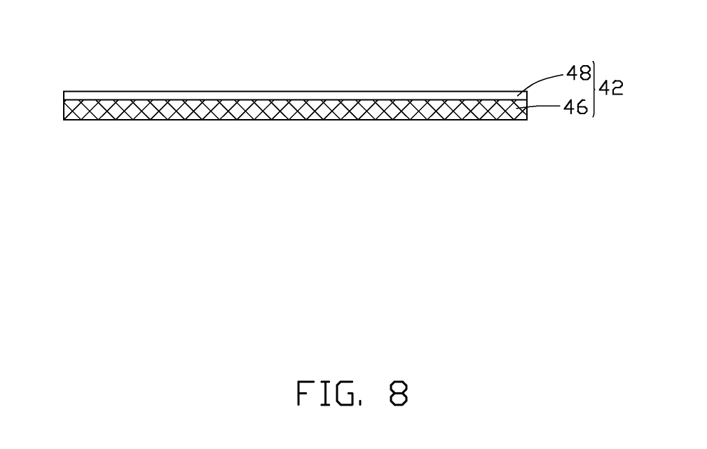

As shown in FIG. 8, the fourth embodiment can adopt the steps of the first, second and third embodiments, but the workpieces 12, 22 and 32 made by metal are replaced by a workpiece composite in the fourth embodiment. For example, a workpiece 42 includes a base 46 and a metal layer 48 covering on the base 46. The base 46 may be made of plastic, glass, ceramics, polycarbonate, poly methyl methacrylate, glass fibers-nylon composite, or any composite thereof. The metal layer 48 may be made stainless steel, copper, iron, titanium, aluminum, magnesium or any alloy thereof, but if not limited thereto. The metal layer 48 can be formed by any processes, such as physical vapor deposition (PVD) or chemical vapor deposition (CVD).

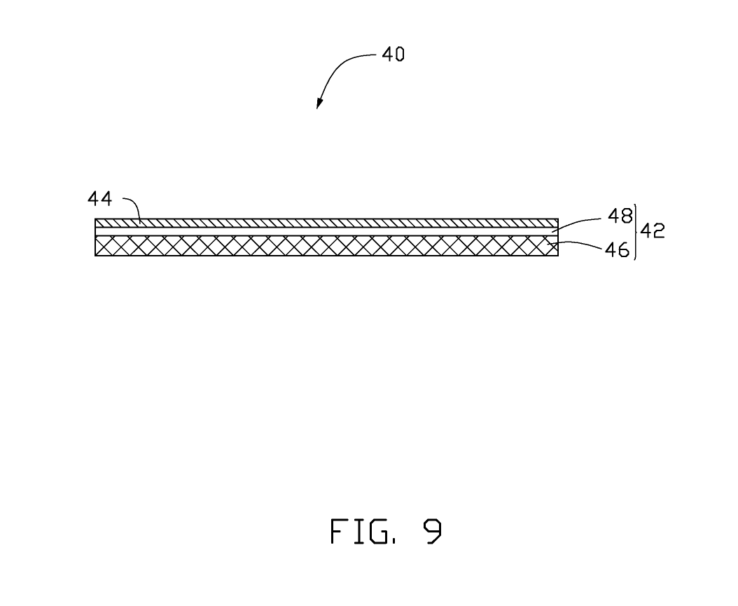

As shown in FIG. 9, a metal housing 40 including a workpiece 42 and a titanium-containing diffusion layer 44 that is formed after the pre-treatment and the titanium diffusion treatment. The titanium-containing diffusion layer 44 may be formed by any of the above mentioned diffusion treatments.

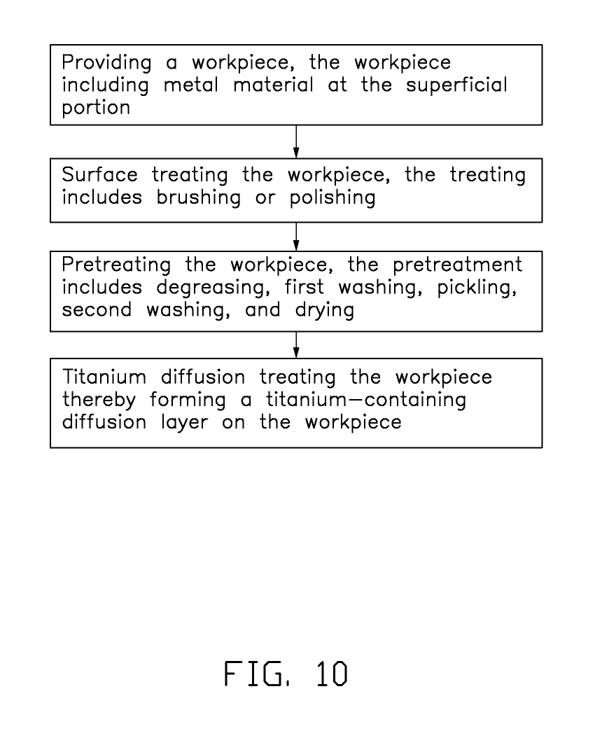

As shown in FIG. 10, since the present disclosure can maintain the original size and the physical characteristics of the workpiece, such as thickness, color and texture, methods of the present disclosure can be easily integrated with other surface treatments. For example, one or more surface treatments, such as brushing or polishing, can be performed first, and thereafter the pre-treatment and the titanium diffusion treatment are performed. Accordingly, a metal housing including a brushed surface or a polished surface and having enhanced surface hardness is formed.

In summary, the present disclosure increases the wear resistance, heat resistance, corrosion resistance of the housing, and therefore increases the length of product lifetime. Furthermore, the present disclosure can maintain the size and the appearance characteristics of the original workpiece, such as thickness, color and texture, so durable housings having metallic texture can be provided for various products.

It is to be understood, however, that even though numerous characteristics and advantages of the present embodiments have been set fourth in the foregoing description, together with details of the structures and functions of the embodiments, the disclosure is illustrative only, and changes may be made in details, especially in matters of shape, size, and arrangement of parts within the principles of the disclosure to the full extent indicated by the broad general meaning of the terms in which the appended claims are expressed.

What is claimed is:

1. A surface treating method of a metal housing, comprising:
providing a workpiece, the workpiece comprising a surface formed by a metal material;
pre-treating the surface of the metal material, the pretreating comprising a degreasing step; and
titanium diffusion treating the surface of the metal material to form a titanium-containing diffusion layer on the surface of the metal material, the titanium-containing diffusion layer comprising a portion of the metal material doped by titanium.

2. The method of claim 1, wherein the workpiece consists essentially of metal.

3. The method of claim 2, wherein the workpiece is selected from the group consisting of copper, iron, titanium, aluminum, magnesium, and any alloy thereof.

4. The method of claim 3, wherein the workpiece consists essentially of stainless steel.

5. The method of claim 1, further comprising surface treating the surface of the metal material before the pre-treating, and the surface treating is selected from the group consisting of a brushing treatment and a polishing treatment.

6. The method of claim 1, wherein the pre-treating further comprises a first washing step, a pickling step, a second washing step and a drying step after the degreasing step.

7. The method of claim 1, wherein the titanium diffusion treating comprises soaking the workpiece in a salt bath.

8. The method of claim 7, wherein the salt bath comprises sodium dioxide and a compound selected from the group consisting of sodium cyanate and potassium cyanate.

9. The method of claim 7, wherein the workpiece is soaked at a temperature from 500 C to 600 C, for a time between about 1 hour to about 20 hours.

10. The method of claim 9, wherein the workpiece is soaked at a temperature from 550 C to 600 C, for a time between about 2 hour to about 10 hours.

11. The method of claim 1, wherein the titanium diffusion treating is a glow-discharge titanizing with an arc source, the titanium diffusion treating comprising:
providing a glow discharge plasma arc apparatus, the glow discharge plasma arc apparatus comprising a cathode electrode, an auxiliary electrode and an anode electrode;
placing the workpiece among the cathode electrode, the auxiliary electrode and the anode electrode; and
providing current to cause discharges, the discharges causing high power titanium to bombard the surface of the metal material, so the workpiece gets hotter, and titanium being diffused into the metal material to form the titanium-containing diffusion layer.

12. The method of claim 1, wherein the titanium diffusion treating is selected from the group consisting of powder diffusion, liquid diffusion, gas diffusion, double glow plasma titanium diffusion, and multi-arc plasma titanium diffusion.

13. The method of claim 1, wherein the workpiece comprises a base and a metal layer covering on the base.

14. The method of claim 13, wherein the base is selected from the group consisting of plastic, glass, ceramics, polycarbonate, poly methyl methacrylate, glass fibers-nylon composite, and any composite thereof.

15. The method of claim 13, wherein the metal layer is selected from the group consisting of copper, iron, titanium, aluminum, magnesium or any alloy thereof.

16. The method of claim 13, wherein the metal layer essentially consists of stainless steel.

17. A metal housing, comprising:
a workpiece, the workpiece comprising a surface formed by a metal material; and
a titanium-containing diffusion layer located on the surface of the metal material, wherein the titanium-containing diffusion layer comprising a portion of the metal material doped by titanium, and a surface hardness of the titanium-containing diffusion layer equal to or exceed HRC (hardness Rockwell C) 60.

18. The metal housing of claim 17, wherein a thickness of the titanium-containing diffusion layer is substantially between 20 microns and 125 microns.

19. The metal housing of claim 17, wherein the workpiece essentially consists of metal.

20. The metal housing of claim 17, wherein the workpiece is selected from the group consisting of stainless steel, copper, iron, titanium, aluminum, magnesium and any alloy thereof.
